(19) United States
(12) Patent Application Publication
(10) Pub. No.: US 2011/0241263 A1
(43) Pub. Date: Oct. 6, 2011

(54) DRYING APPARATUS AND DRYING METHOD FOR HONEYCOMB FORMED BODY

(75) Inventor: Shuichi TAKAGI, Nagoya-City (JP)

(73) Assignee: NGK Insulators, Ltd., Nagoya-City (JP)

(21) Appl. No.: 13/042,740

(22) Filed: Mar. 8, 2011

(30) Foreign Application Priority Data
Mar. 30, 2010 (JP) 2010-078166

(51) Int. Cl. H05B 6/64; B29C 35/08

(52) U.S. Cl. 264/489; 425/174.4

(57) ABSTRACT

A drying apparatus for honeycomb formed bodies includes: a drying chamber having a drying space to store undried honeycomb formed bodies; a microwave generator that generates microwaves; and a plurality of waveguides for introducing the microwaves into the drying chamber. On side surfaces of the drying chamber, provided is a plurality of microwave introduction ports for introducing the microwaves generated by the microwave generator into the drying space inside the drying chamber, the waveguides are disposed at the microwave introduction ports, and irradiation ports of the waveguides are provided directed to two or more different directions toward the drying space of the drying chamber.

### BACKGROUND OF THE INVENTION

1. Field of the Invention

The present invention relates to a drying apparatus and a drying method for honeycomb formed bodies.

2. Related Background of the Invention

A honeycomb structure made of ceramics has been widely used for catalyst carriers, various filters, etc. Recently, the structure has particularly attracted the attention as a diesel particulate filter (DPF) for trapping particulate matters (PM) discharged from a diesel engine.

Such honeycomb structure can generally be obtained by kneading a raw material composition obtained through addition of an auxiliary forming agent and various addition agents to dispersion media, such as a ceramic material and water to form a clay, then extruding the clay into a honeycomb-shaped formed body (honeycomb formed body), drying this honeycomb formed body, and then firing the honeycomb formed body.

As means for drying a honeycomb formed body, there have been known a natural drying method in which the honeycomb formed body is simply left under a room temperature condition, a hot-air drying method in which the honeycomb formed body is dried by a hot air generated with a gas burner, and a dielectric drying method in which the honeycomb formed body is dried utilizing high-frequency energy generated by causing a current to flow between electrodes provided at an upper side and a lower side of the honeycomb formed body, but recently, a microwave drying method utilizing microwaves has been performed instead of these drying methods, or together with them.

This microwave drying is performed, for example, after electric field distribution in a drying furnace is uniformed to then place the honeycomb formed bodies to be dried therein. As means for uniformizing the electric field distribution, there have been known a method for adjusting a shape and placement of an antenna that radiates microwaves, and a method for using a stirrer fan, etc. As prior art documents on the microwave drying method, Japanese Patent Laid-Open No. 2002-283330, Japanese Patent Laid-Open No. 2004-167809, International Publication Pamphlet 2005/023503, Japanese Patent Laid-Open No. 2000-44326, and Japanese Utility Model Laid-Open No. 1986-13497 are cited.

### SUMMARY OF THE INVENTION

However, when the honeycomb formed body is dried with the microwave drying method, it is difficult to dry the whole honeycomb formed body at a uniform speed. In other words, for example, drying of a center of the honeycomb formed body may be more delayed than the other portions thereof. Since the honeycomb formed body is shrunk by water evaporation therefrom, when a difference of a drying speed (difference of a water amount) in an inside of the formed body occurs, deformation is caused and the yield is reduced. Moreover, when the honeycomb formed body is dried with the microwave drying method, drying cracks may occur therein. These problems tend to occur particularly in cases where the honeycomb formed body is the one with a high water content ratio before dried, with a large size, with thick partition walls (with large thickness), with a small opening area of an end surface, formed of a material with large dielectric loss, etc.

Although rotation of the honeycomb formed body is effective to uniformly irradiate microwaves thereto, a rotation mechanism causes the drying apparatus to be complicated and expensive. It is particularly remarkable in a continuous microwave drying apparatus. In the continuous microwave drying apparatus, it is aimed to average microwave electric field having strength and weakness in a longitudinal direction of the furnace by moving the honeycomb formed body in a traveling direction, and as a result of it, to uniformly irradiate the honeycomb formed body with microwaves, but actually, microwave irradiation becomes non-uniform in some cases. Although arrangement of irradiation ports and reflecting plates is devised or a stirrer fan etc. are used in the prior art documents, it is not easy to achieve uniformization. If size of a furnace body is made larger, better uniformization can be achieved, but there is a limit to it.

An object of the present invention is to provide a drying apparatus and a drying method for a honeycomb formed body with which the whole honeycomb formed body can be dried at a uniform speed, and with which drying cracks do not easily occur.

The present inventor has found out that the above-described problems can be solved by changing directions of the microwave irradiation ports. Namely, according to the present invention, the following drying apparatus and drying method for honeycomb formed bodies are provided.

[1] A drying apparatus for a honeycomb formed body, that is capable of obtaining a dried honeycomb formed body by irradiating with microwaves and microwave-heating an undried honeycomb formed body as the undried honeycomb formed body which is composed of a raw material composition containing a ceramic material and water, and in which a plurality of cells is partitioned and formed by partition walls, and thereby evaporating water from an inside and an outside of said undried honeycomb formed body to dry said undried honeycomb formed body, the drying apparatus comprising: a drying chamber having a drying space to store said undried honeycomb formed body; a microwave generator generating said microwaves to be irradiated to the undried honeycomb formed body that is stored in said drying chamber is radiated; and a plurality of waveguides for introducing the microwaves generated by said microwave generator into said drying chamber, wherein on side surfaces of said drying chamber, provided is a plurality of microwave introduction ports for introducing the microwaves generated by said microwave generator into said drying space inside the drying chamber, said waveguides are disposed at said microwave introduction ports, and irradiation ports of said waveguides are provided directed to two or more different directions toward said drying space of the drying chamber.
[2] The drying apparatus for the honeycomb formed body according to [1], wherein flanges are formed for removably holding said waveguides provided toward said drying space at said microwave introduction ports on the side surfaces of said drying chamber.
[3] The drying apparatus for the honeycomb formed body according to [2], wherein said waveguides are formed into a bent shape to change directions of said microwaves in said drying chamber, and have flanges for allowing the flanges to be removable from said flanges of said drying chamber, and the radiation directions of said microwaves can be changed depending on attachment directions of said waveguides to said flanges of said drying chamber.
[4] The drying apparatus for the honeycomb formed body according to any of [1] to [3], which is a continuous drying apparatus that continuously introduces/discharges a plurality of said honeycomb formed bodies into/from said drying chamber, wherein said irradiation ports of said waveguides are provided parallel or vertical with respect to a conveying direction of said honeycomb formed bodies in said drying chamber.
[5] The drying apparatus for the honeycomb formed body according to [4], wherein a percentage of the parallel direction of the waveguides is 30 to 70%.
[6] The drying apparatus for the honeycomb formed body according to [5], wherein a percentage of an upstream direction in said conveying direction of said parallelly directed waveguides is 40 to 60%.
[7] The drying apparatus for the honeycomb formed body according to any of [1] to [3], which is the continuous drying apparatus that continuously introduces/discharges the plurality of said honeycomb formed bodies into/from said drying chamber, wherein the directions of said irradiation ports of said waveguides are set in vertical directions with respect to the conveying direction of said honeycomb formed bodies in said drying chamber and in upward/downward directions to be more upward or downward than said vertical directions, and a percentage of the upward/downward directions is 30 to 70%.
[8] The drying apparatus for the honeycomb formed body according to [7], wherein a percentage of the upward waveguides in said upward and downward waveguides is 50%.
[9] A drying method for honeycomb formed bodies using the drying apparatus for the honeycomb formed bodies according to any of [1] to [8], wherein said honeycomb formed bodies are conveyed with an interval therebetween not less than twice as long as a distance between said irradiation ports.

Since the irradiation ports of the waveguides are provided directed to two or more different directions toward the drying space of the drying chamber, it becomes possible to uniformly dry the honeycomb formed body, thus enabling to prevent drying cracks and cell deformation and to stabilize a shape thereof.

### BRIEF DESCRIPTION OF THE DRAWINGS

FIG. 1 is a cross-sectional view schematically showing a cross section parallel to a conveying direction of honeycomb formed bodies of one embodiment of a drying apparatus for the honeycomb formed bodies of the present invention;

FIG. 2A is a cross-sectional view schematically showing a cross section vertical to the conveying direction of the honeycomb formed bodies of one embodiment of the drying apparatus for the honeycomb formed bodies of the present invention;

FIG. 2B is a schematic view showing a flange formed at a microwave introduction port on a side surface of a drying chamber;

FIG. 3A is a schematic view showing arrangement of waveguides of a first embodiment when the drying apparatus for the honeycomb formed bodies of the present invention is viewed from above and a side;

FIG. 3B is a schematic view showing arrangement of waveguides of a second embodiment when the drying apparatus for the honeycomb formed bodies of the present invention is viewed from above and a side;

FIG. 3C is a schematic view showing arrangement of waveguides of a third embodiment when the drying apparatus for the honeycomb formed bodies of the present invention is viewed from above and a side;

FIG. 3D is a schematic view showing arrangement of waveguides of a fourth embodiment when the drying apparatus for the honeycomb formed bodies of the present invention is viewed from above and a side;

FIG. 3E is a schematic view showing arrangement of waveguides of a fifth embodiment when the drying apparatus for the honeycomb formed bodies of the present invention is viewed from above and a side;

FIG. 4 is a view showing one embodiment of a waveguide;

FIG. 5A is a schematic view for illustrating a drying method for honeycomb formed bodies of the present invention, in which a conveying interval thereof is changed;

FIG. 5B is a schematic view showing another embodiment for illustrating the drying method for the honeycomb formed bodies of the present invention, in which a conveying interval thereof is changed;

FIG. 6A is a view showing one example of a honeycomb formed body, which is a body to be dried with the drying method for the honeycomb formed bodies according to the present invention, in which an end surface is viewed in an axial direction;

FIG. 6B is a cross-sectional view showing an A-A cross section in FIG. 6A;

FIG. 7A is a graph having a view therewith for illustrating an evaluation method of the drying method for the honeycomb formed bodies of the present invention;

FIG. 7B is a view for illustrating measurement points of water amount differences in Table 2;

FIG. 8A is a schematic view showing arrangement of waveguides when a conventional drying apparatus for honeycomb formed bodies is viewed from above, in which an embodiment is shown that conveys honeycomb formed bodies in a state of being vertically placed;

FIG. 8B is a schematic view showing arrangement of the waveguides when the conventional drying apparatus for the honeycomb formed bodies is viewed from a side, in which an embodiment is shown that conveys honeycomb formed bodies in a state of being laterally placed;

FIG. 9A is a schematic view showing arrangement of waveguides of an embodiment in which a percentage of upwardly and downwardly directed waveguides is 20%;

FIG. 9B is a schematic view showing arrangement of waveguides of an embodiment in which a percentage of upwardly and downwardly directed waveguides is 50%;

FIG. 10A is a schematic view showing arrangement of waveguides of an embodiment in which a percentage of parallelly directed waveguides is 50%, and a percentage of upstream directed waveguides is 40%;

FIG. 10B is a schematic view showing arrangement of waveguides of an embodiment in which a percentage of parallelly directed waveguides is 50%, and a percentage of upstream directed waveguides is 60%; and

FIG. 11 is a view for illustrating measurement points of water amount differences in Table 3.

### EXPLANATIONS OF NUMERALS

1: Honeycomb formed body
2: Partition wall
3: Cell
4: Outer wall
21: Drying apparatus
22: Drying chamber
22a: Side surface (of drying chamber)
23: Microwave introduction port
23a: Flange (of microwave introduction port)
24: Conveying pallet
26: Waveguide
26a: Flange (of waveguide)
26b: Bolt hole
26c: Irradiation port
28: Belt conveyor
29: Carry-in entrance
30: Carry-out exit
35: Microwave generator

### DESCRIPTION OF THE PREFERRED EMBODIMENTS

Hereinafter, embodiments of the present invention will be described with reference to drawings. The present invention is not limited to the following embodiments, but they can be changed, modified, and improved unless departing from the scope of the invention.

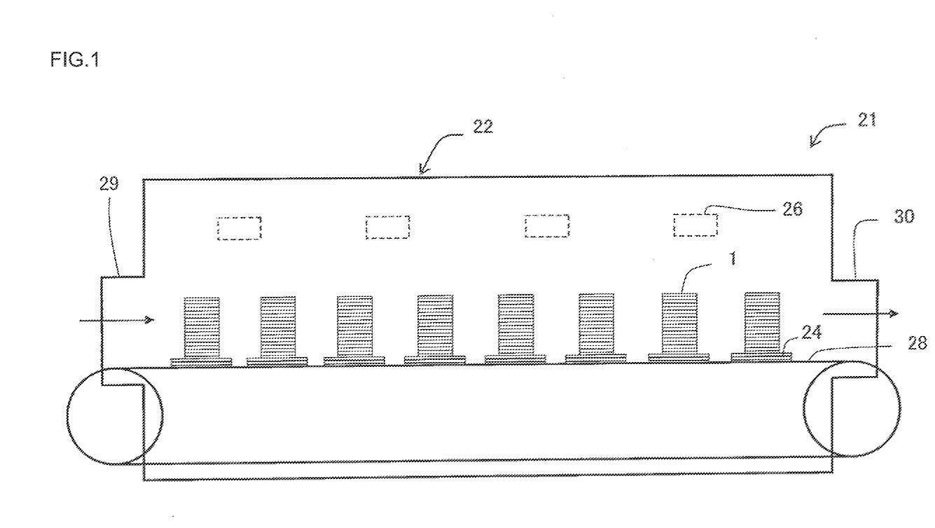

As shown in FIG. 1, a drying apparatus 21 for a honeycomb formed body 1 of the present invention is the apparatus that is capable of obtaining a dried honeycomb formed body by irradiating with microwaves and microwave-heating an undried honeycomb formed body as the undried honeycomb formed body 1 which is comprised of a raw material composition containing a ceramic material and water, and in which a plurality of cells 3 is partitioned and formed by partition walls 2, and thereby evaporating water from an inside and an outside of said undried honeycomb formed body to dry said undried honeycomb formed body. The drying apparatus 21 includes: a drying chamber 22 having a drying space to store undried honeycomb formed bodies; a microwave generator 35 generating microwaves to be irradiated to the undried honeycomb formed body that is stored in the drying chamber 22; and a plurality of waveguides 26 for introducing the microwaves generated by the microwave generator 35 into the drying chamber 22. On side surfaces of the drying chamber 22, provided is a plurality of microwave introduction ports 23 for introducing the microwaves generated by the microwave generator 35 into the drying space inside the drying chamber 22, the waveguides 26 are disposed at the microwave introduction ports 23, and irradiation ports 26c of the waveguides 26 are provided directed to two or more different directions toward the drying space of the drying chamber 22.

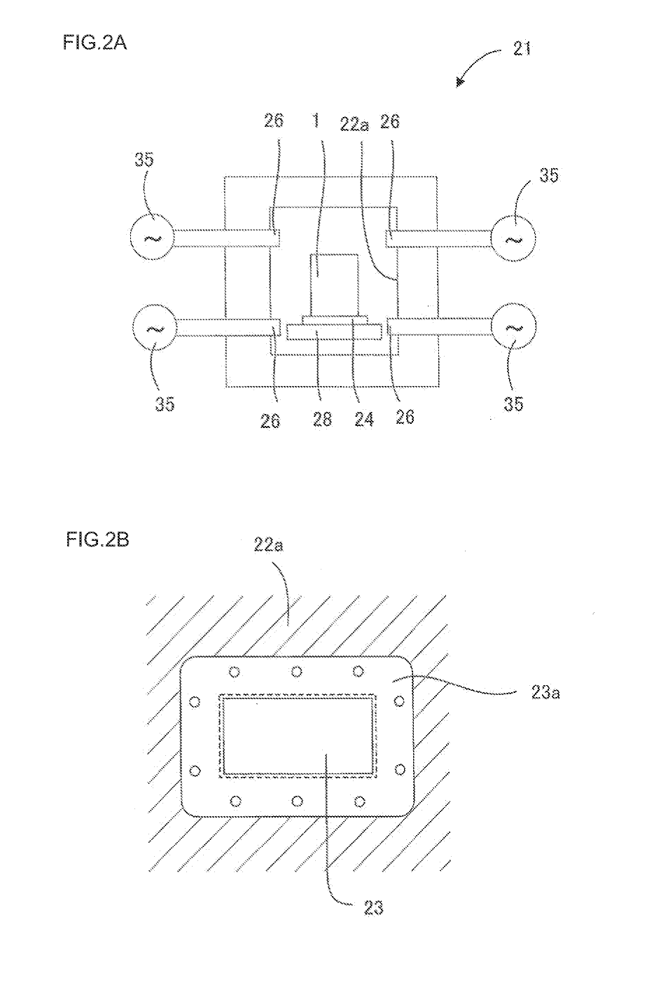

FIG. 1 is a cross-sectional view schematically showing a cross section parallel to a conveying direction of the honeycomb formed body 1 of one embodiment of the drying apparatus 21 for the honeycomb formed body 1 of the present invention. FIG. 2A is a cross-sectional view schematically showing a cross section vertical to the conveying direction of the honeycomb formed body 1 of one embodiment of the drying apparatus 21 for the honeycomb formed body 1 of the present invention. The drying apparatus 21 for the honeycomb formed body 1 of the embodiment includes the drying chamber 22 for drying the unfired honeycomb formed body 1 thereinside, and waveguides 26 at the microwave introduction ports 23 in order to introduce microwaves of the drying chamber 22 into the drying chamber 22.

In addition, the drying chamber 22 includes a belt conveyor 28, and is formed so that conveying pallets 24 may be conveyed from a carry-in entrance 29 toward a carry-out exit 30 on the belt conveyor 28. Subsequently, the honeycomb formed bodies 1 placed on the conveying pallets 24 are carried in to be dried in this drying chamber 22. Although the honeycomb formed bodies 1 are conveyed in a state of being aligned in a line within the drying chamber 22 in the embodiment, they may be conveyed in two or more lines, i.e., in a plurality of lines. The drying apparatus 21 for the honeycomb formed bodies 1 of the embodiment is a continuous drying apparatus in which the honeycomb formed bodies 1 are conveyed on the belt conveyor.

In a drying method for the honeycomb formed bodies 1 of the embodiment, microwaves which microwave-heats the unfired honeycomb formed bodies 1 are introduced through the waveguides 26. A frequency of the microwaves is preferably 900 to 30000 MHz, and particularly preferably 900 to 3000 MHz.

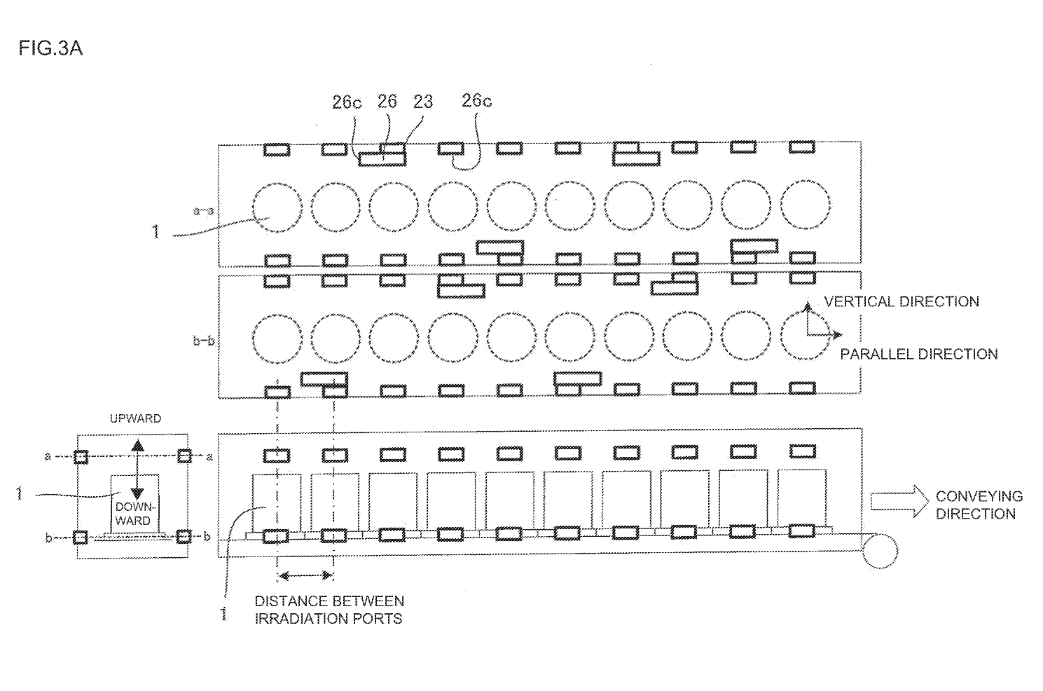

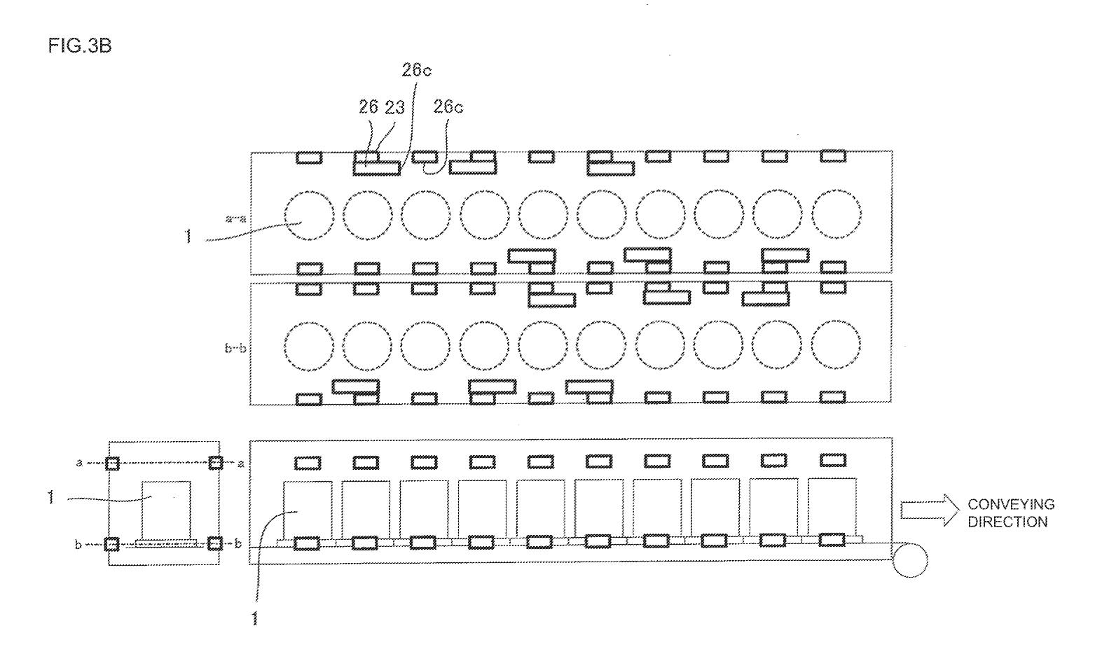

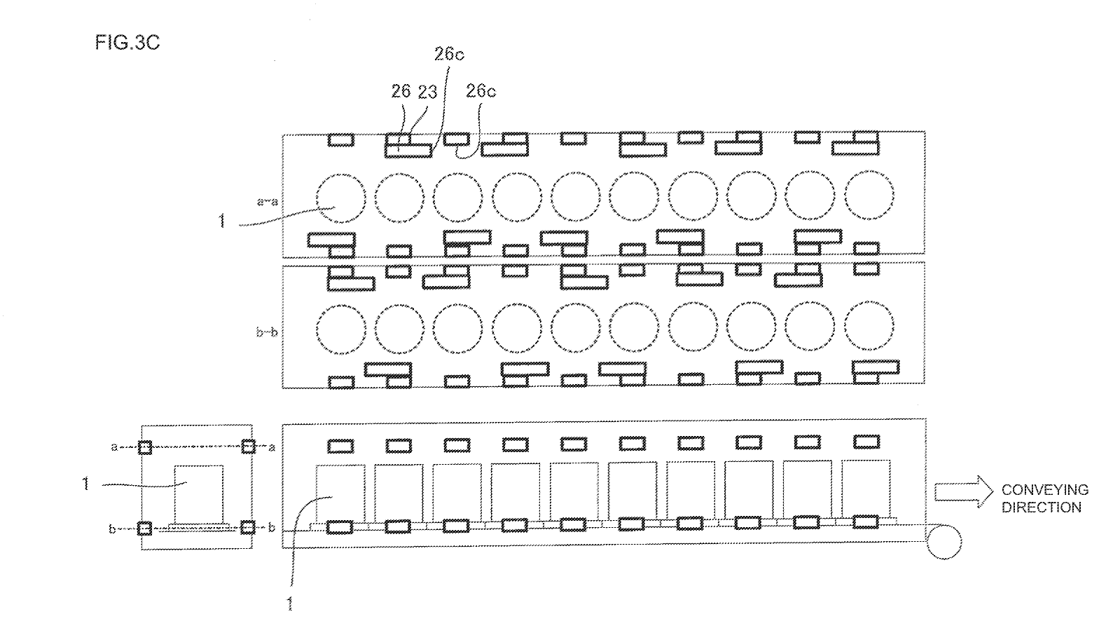

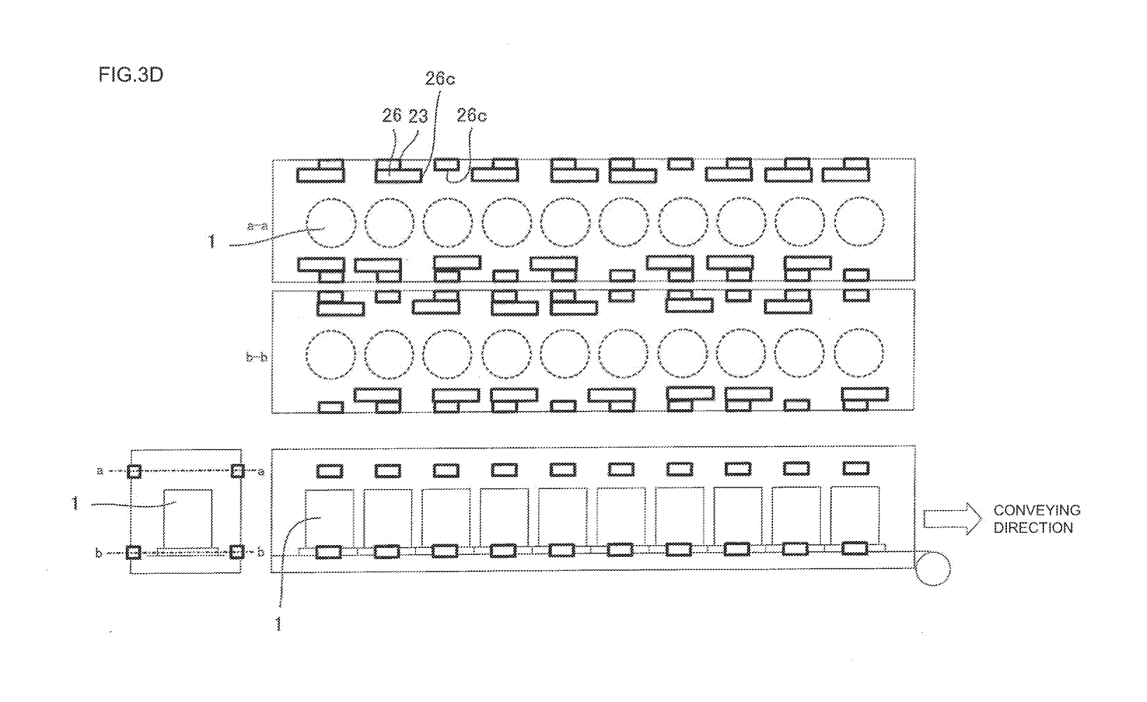

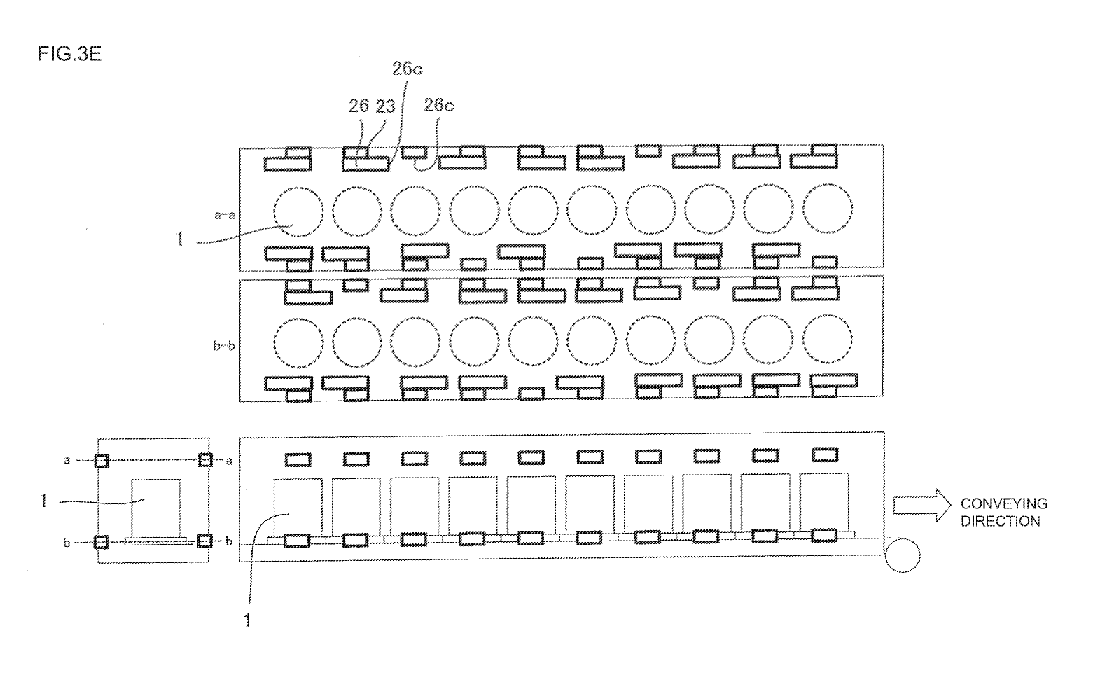

In FIGS. 3A to 3E, shown are schematic views of the drying apparatus 21 for the honeycomb formed bodies 1 when it is viewed from above and a side. The microwave introduction ports 23 are formed on side surfaces 22a of the drying chamber 22 in the conveying direction. As shown in FIG. 2B, a flange 23a for removably holding the waveguide 26 provided toward the drying space is formed at the microwave introduction port 23, and the waveguide 26 is attached to the flange 23a. The plurality of microwave introduction ports 23 is provided on the side surfaces 22a of the drying chamber 22, and the waveguides 26 are provided at the microwave introduction ports 23 with the irradiation ports 26c thereof being directed to the drying space of the drying chamber 22. It is to be noted that the waveguides 26 are not necessarily attached to all the microwave introduction ports 23, and they may be attached to 30 to 70% of all the microwave introduction ports 23.

It is preferable that the plurality of waveguides 26 is partially formed into a bent shape in the drying chamber 22. Namely, it is preferable that the waveguides 26 are configured to be formed into the bent shape in order to change directions of the microwaves, and to have flanges for allowing the flanges to be removable from the flanges of the drying chamber 22. Configuration as described above enables to change irradiation directions of the microwaves depending on attachment directions of the waveguides 26 to the flanges 23a of the microwave introduction ports 23.

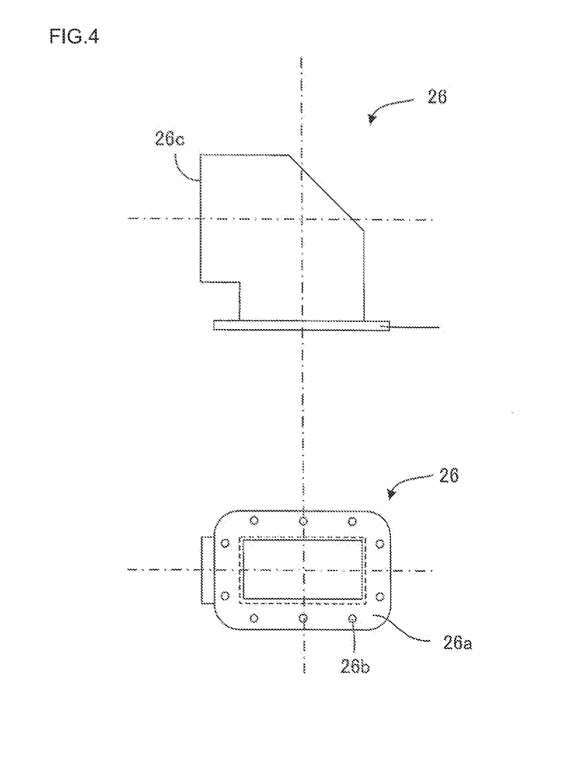

An embodiment of the waveguide 26 is shown in FIG. 4. The waveguide 26 shown in FIG. 4 is a bent waveguide 26 formed into the bent shape so that an exit direction of the microwaves may change by 90 degrees with respect to an entry direction thereof. The waveguide 26 in FIG. 4 has a flange 26a formed at one opening end thereof, bolt holes 26b are formed on the flange 26a, and thereby the waveguide 26 can be attached to the flange of the drying chamber 22 with bolts. The bent shape can use an H corner for parallely directed waveguides, and an E corner for upwardly or downwardly directed waveguides. Note that the E corner can be used for parallely directed waveguides depending on the direction of an opening 23 of a furnace body.

The drying apparatus 21 for the honeycomb formed bodies 1 of the present invention is the continuous drying apparatus in which the plurality of honeycomb formed bodies 1 is continuously introduced/discharged into/from the drying chamber 22, and it is preferable to configure such that directions of the irradiation ports 26c of the waveguides 26 are set to be parallel or vertical with respect to the conveying direction of the honeycomb formed bodies 1 in the drying chamber 22, in which a percentage of parallel directions (parallel directions/(parallel directions+vertical directions)) is 30 to 70%. FIG. 3A shows an embodiment configured so that a percentage of the irradiation ports 26c of the waveguides 26 directed parallel with respect to the conveying direction of the honeycomb formed bodies 1 in the drying chamber 22 may be 20%. In addition, FIG. 3B shows an embodiment in which a percentage of the parallel directions is 30%, FIG. 3C; 50%, FIG. 3D; 70%, and FIG. 3E; 80%, respectively. It is to be noted that as shown in FIG. 3A, the conveying direction of the honeycomb formed bodies 1 indicates the parallel direction, and a direction vertical to the conveying direction (horizontal direction crossing a belt of the belt conveyor 28) indicates the vertical direction. In addition, when the waveguides 26 are not attached to the microwave introduction ports 23, microwaves are irradiated to the vertical direction. In the respective embodiments, such examples are shown that the directions of the irradiation ports 26c are either parallel or vertical, and that the irradiation ports 26c are arranged so as not to incline to the respective directions. The drying apparatus 21 in which the directions of the irradiation ports 26c of the waveguides 26 are set to be parallel and vertical is suitable when the honeycomb formed body 1 is conveyed in a state where one of the opening end surfaces thereof is placed vertically and downwardly on a drying tray (conveying pallet 24) (vertically placed).

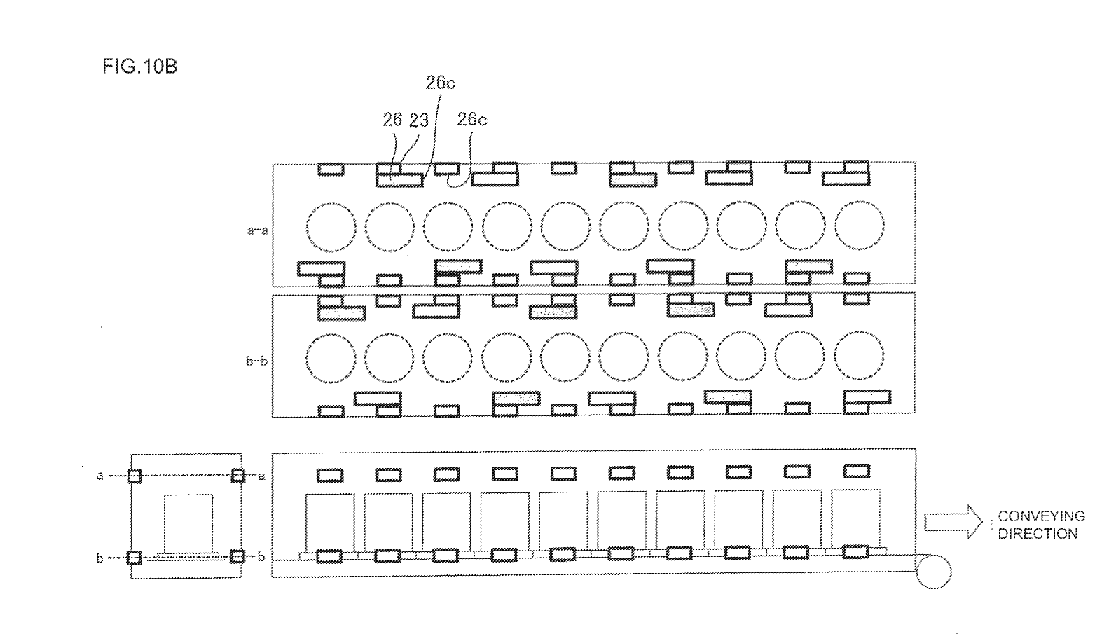

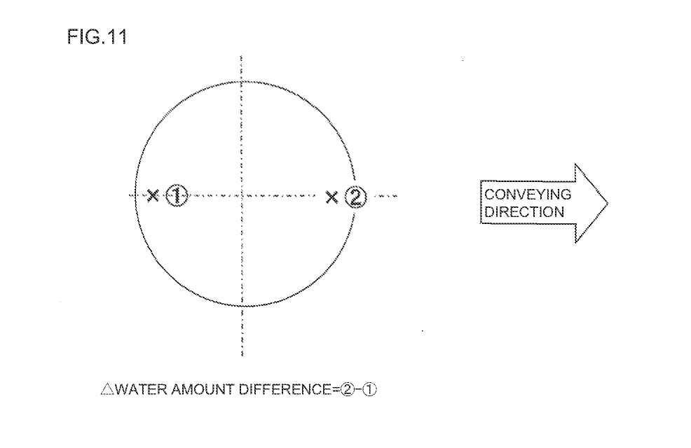

It is preferable that directions of the waveguides 26 are set to be parallel or vertical with respect to the conveying direction of the honeycomb formed bodies 1 in the drying chamber 22, in which a percentage of the parallel directions (parallel directions/(parallel directions+vertical directions)) is set to be 30 to 70%, it is preferable that a percentage of an upstream direction in the conveying direction of the parallelly directed waveguides 26 (upstream directions/(upstream directions+downstream directions)) is 30 to 70%, more preferable 40 to 60%, and the most preferable 50%. Namely, it is the most preferable that a percentage of the upstream directions and that of the downstream directions are 50-50%. For example, FIGS. 3A to 3E show an embodiment in which the percentage of the upstream directions is 50%. In addition, in FIG. 10A, shown is an embodiment in which the percentage of the upstream directions is 40%, and in FIG. 10B, shown is an embodiment in which the percentage of the upstream directions is 60%

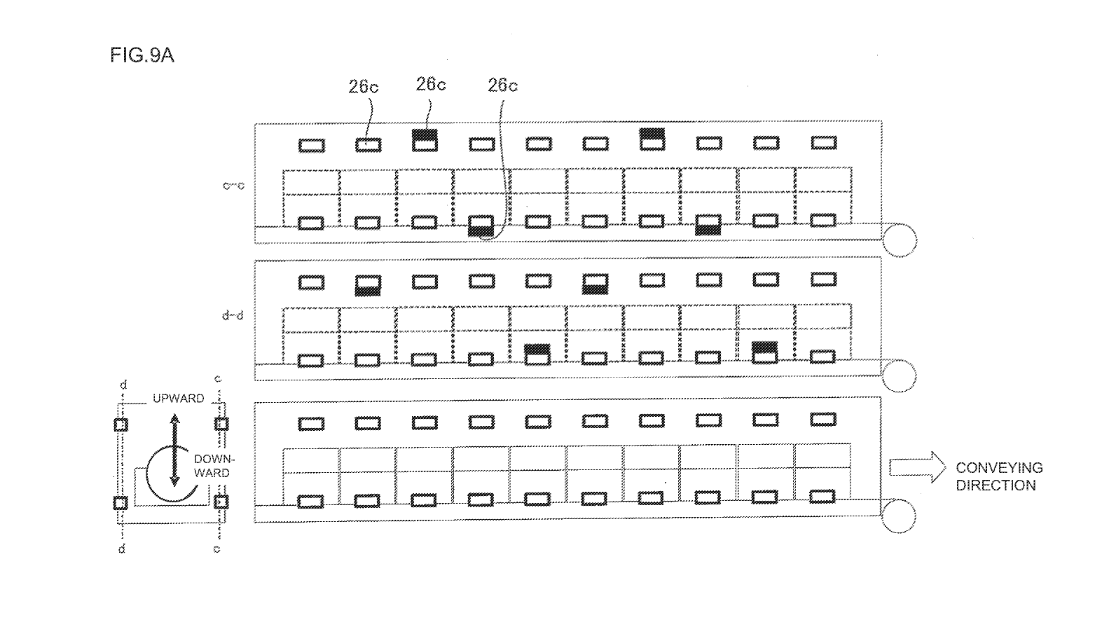

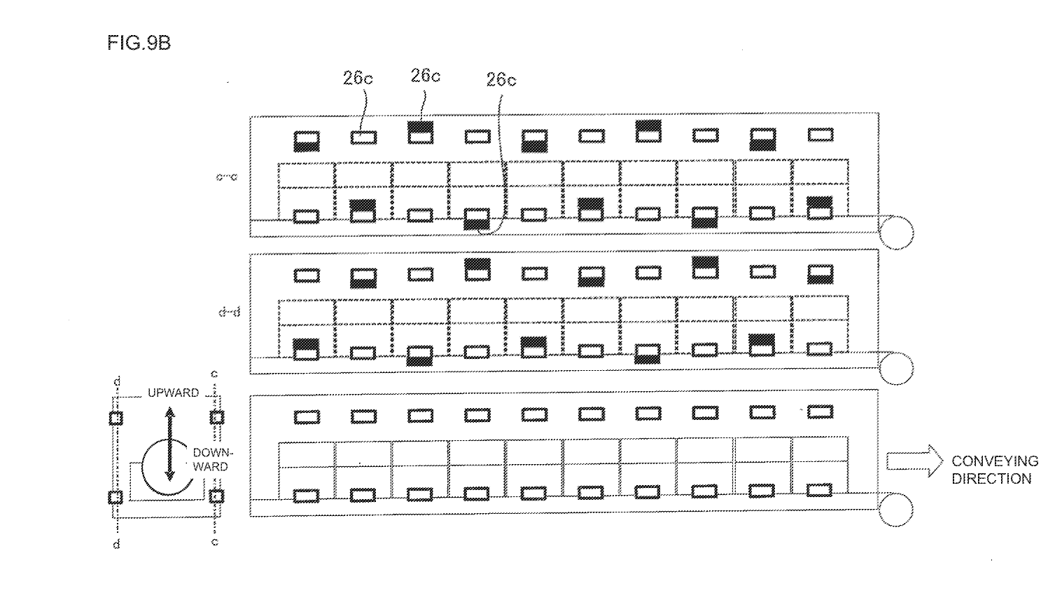

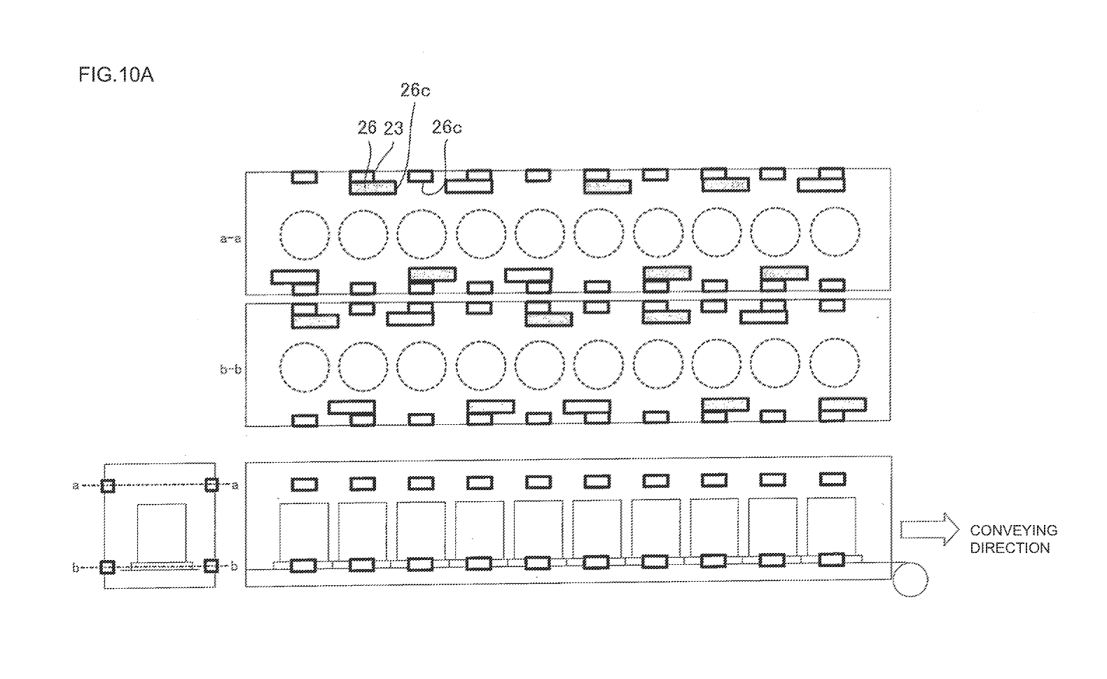

In addition, the drying apparatus 21 for the honeycomb formed bodies 1 of the present invention is the continuous drying apparatus in which the plurality of honeycomb formed bodies 1 is continuously introduced/discharged into/from the drying chamber 22, and it is preferable to configure such that the directions of the irradiation ports 26c of the waveguides 26 are set in vertical directions with respect to the conveying direction of the honeycomb formed bodies 1 in the drying chamber 22, and in upward/downward directions to be more upward or downward than the vertical directions, and a percentage of the upward and downward directions (upward directions/(upward directions downward directions)) is 30 to 70%. In FIG. 9A, shown is an embodiment in which the percentage of the upward and downward directions is 20%, and in FIG. 9B, shown is an embodiment in which the percentage of the upward and downward directions is 50%. The drying apparatus 21 in which the directions of the irradiation ports 26c of the waveguides 26 are set to be vertical and upward and downward is suitable when the honeycomb formed body 1 is conveyed placed on the drying tray (conveying pallet 24) so that one of the opening end surfaces thereof may be in a state of being directed to the conveying direction thereof (laterally placed).

It is preferable that the percentage of the upward directions of the upwardly and downwardly directed waveguides 26 is 30 to 70%, more preferable 40 to 60%, and the most preferable 50%. Namely, it is the most preferable that the percentage of the upward directions and that of the downward directions are 50-50%. FIGS. 9A and 9B show an embodiment in which the percentage of the upward directions is 50%.

An inside of the drying chamber 21 is formed with a metal box so that microwave energy introduced into the drying space may not leak. It is preferable to use SUS as a material of the metal box from the viewpoint of ease of welding, and rustproofing.

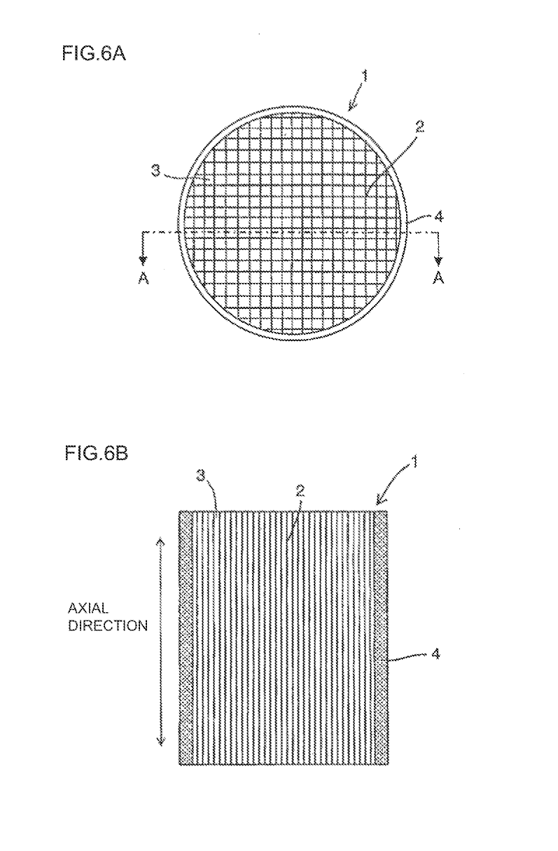

Next will be described the honeycomb formed body 1 to be dried by the drying method for honeycomb formed bodies according to the present invention. The honeycomb formed body 1 shown in FIGS. 6A and 6B is one example of honeycomb formed bodies, and it is a honeycomb-shaped formed body (honeycomb formed body 1) having the plurality of cells 3 that is partitioned by the partition walls 2 and serves as fluid through channels. In this honeycomb formed body 1, an outer wall 4 is disposed on an outer periphery so as to surround the plurality of cells 3, and an outline shape of the honeycomb formed body 1 is a cylinder. The honeycomb formed body 1 has a quadrangular shape of a cross section perpendicular to an axial direction (through-channel direction) of the cells 3. It is to be noted that the shape of the honeycomb formed body 1 to be dried by the drying apparatus 21 and the drying method of the present invention is not limited to the one shown in FIGS. 6A and 613, and it may be a shape, for example, another prismatic shape, such as a triangle pole and a hexagonal column, a cylinder, an elliptic column, etc. In addition, a shape of the cell 3 of the honeycomb formed body 1 is not limited, either and, for example, there can be included a cell shape, such as a quadrangle cell, a hexagon cell, a triangle cell, a circular cell. Further, the honeycomb formed body 1 may be a plugged honeycomb formed body (HAC (High Ash Capacity) honeycomb formed body) in which a size of a cell opening of one end surface is different from that of the other end surface.

The honeycomb formed body 1 can be obtained as follows: kneaded to be clay is a raw material made by adding water as a dispersion medium, an auxiliary forming agent, and an addition agent to a ceramic material; and after that, for example, the clay is extrusion-formed.

The honeycomb formed body 1 before dried (undried honeycomb formed body) is preferably an unfired one (referred to as an unfired body) of not less than 20% by mass and not more than 60% by mass. The unfired body means the body in a state where particles of the used ceramic material exist maintaining a form of particle at the time of forming, and where the ceramic material has not been sintered.

As the ceramic material, for example, there can be included oxide-based ceramics, such as a raw material made into cordierite, alumina, mullite, and zirconia, or non-oxide-based ceramics, such as silicon carbide, silicon nitride, aluminum nitride, aluminum titanate, lithium aluminum titanate, and Al₄SiC₄, etc. Moreover, it is possible to use a composite material of silicon carbide/metal silicon, and a composite material of silicon carbide/graphite, etc.

As the auxiliary forming agent (binder), there can be included, for example, polyvinyl alcohol, polyethylene glycol, starch, methylcellulose, carboxymethylcellulose, hydroxyethylcellulose, hydroxypropylmethylcellulose, polyethylene oxide, sodium polyacrylate, polyacrylamide, polyvinyl butyral, ethylcellulose, cellulose acetate, polyethylene, ethylene-vinyl acetate copolymer, polypropylene, polystyrene, acrylic resin, polyamide resin, glycerin, polyethylene glycol, dibutyl phthalate, etc.

As a specific example of the ceramic material that constitutes the outer wall 4 disposed on the outer periphery in the honeycomb formed body 1, similar ceramic materials to the above can be included.

Note that in a manufacturing method of a honeycomb structure obtained by firing the honeycomb formed body 1 after drying it, included are a method for manufacturing a honeycomb structure in which partition walls 2 and an outer wall surrounding them are integrally formed, and a method for manufacturing a honeycomb structure having an outer wall by processing an outer periphery of the partition walls 2 after forming them, and then by newly coating a surface of the processed outer periphery with a cement coat layer with aggregate formed of a ceramic material, and the honeycomb formed body 1 shown in FIGS. 6A and 6B is the honeycomb formed body 1 as an intermediate body in the former manufacturing method. In a case of the latter manufacturing method, the honeycomb formed body 1 to be dried does not have an outer wall.

In the embodiments shown in FIGS. 3A to 3E, the honeycomb formed bodies 1 are carried into the drying chamber 22 through the carry-in entrance 29 with the same interval between the honeycomb formed bodies 1 as an interval between the microwave introduction ports 23 in the conveying direction. Subsequently, the honeycomb formed bodies 1 are heated to be dried with microwaves while being conveyed in the conveying direction. According to the drying apparatus 21 for the honeycomb formed body 1 of the present invention, it is possible to dry the whole honeycomb formed body 1 at a uniform speed since the microwaves in the drying chamber 22 are uniformized better than in a conventional apparatus, and thus drying cracks do not easily occur in the honeycomb formed body 1.

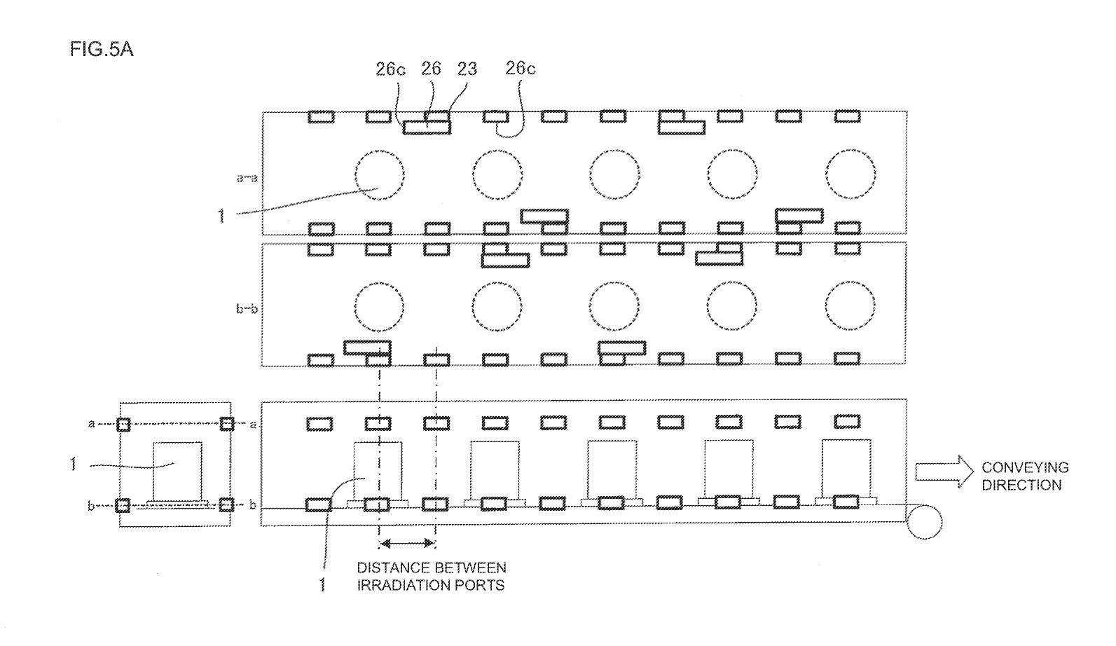

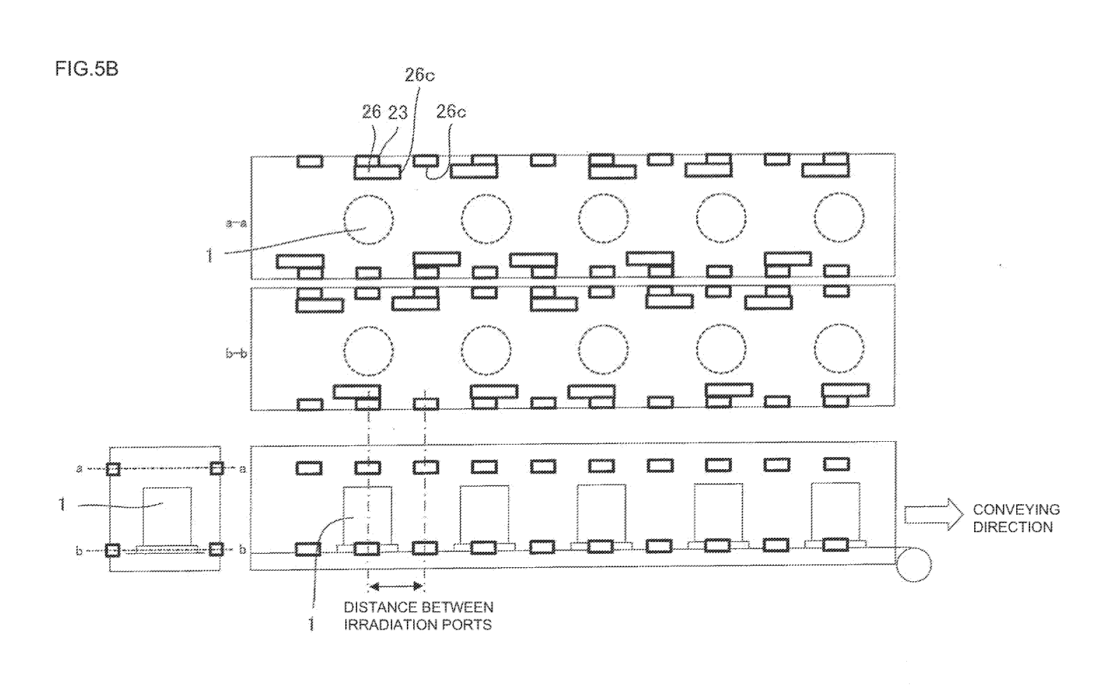

In the drying method for honeycomb formed bodies of the present invention, the honeycomb formed bodies 1 are dried while being conveyed with a unit pitch (distance between the irradiation ports) or with not less than twice the unit pitch in a continuous drying apparatus. In the drying method for the honeycomb formed bodies using the drying apparatus 21 for the honeycomb formed bodies 1 of the present invention, it is preferable to convey the honeycomb formed bodies 1 with an interval therebetween not less than twice a distance between the irradiation ports 26c (the interval is not limited to an integral multiple, but may be 2.5 times etc.). In FIGS. 5A and 5B, shown is the drying method for the honeycomb formed bodies 1 in which they are conveyed with the interval therebetween not less than twice the distance between the irradiation ports 26c. The honeycomb formed bodies 1 are dried while being conveyed with an interval therebetween as described above, thereby enabling to dry the honeycomb formed bodies 1 more uniformly. Particularly, in FIG. 5A showing a case where parallelly directed waveguides are less than 50%, the method, in which the honeycomb formed bodies 1 are conveyed with the interval therebetween not less than twice the distance between the irradiation ports 26c, has a large effect in uniformly drying the honeycomb formed bodies 1.

### EXAMPLES

Hereinafter, the present invention will be described in more detail based on examples, but it is not limited to these examples.

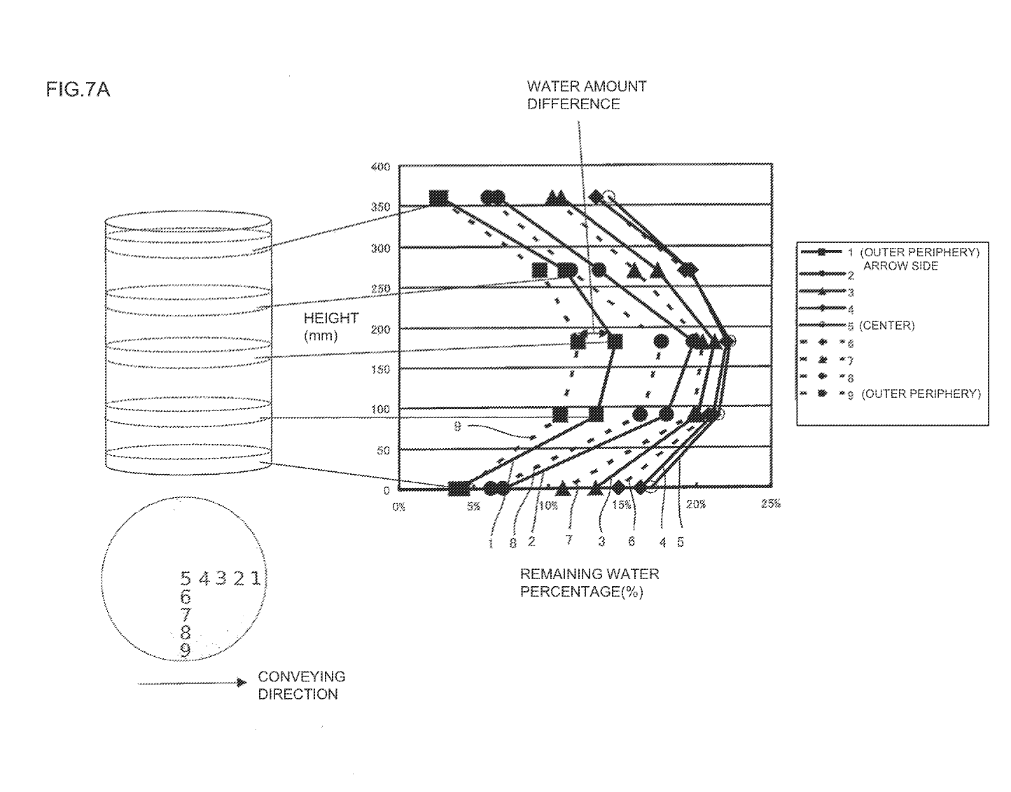

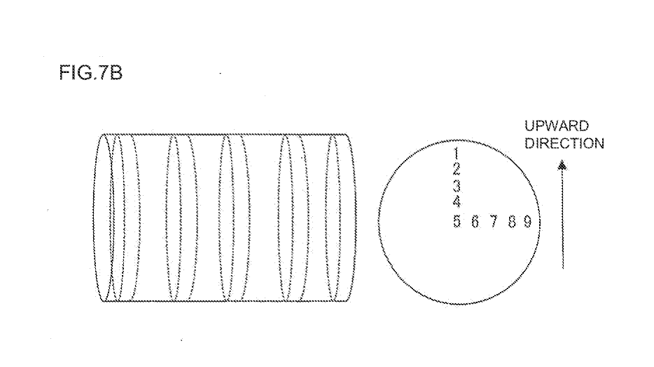

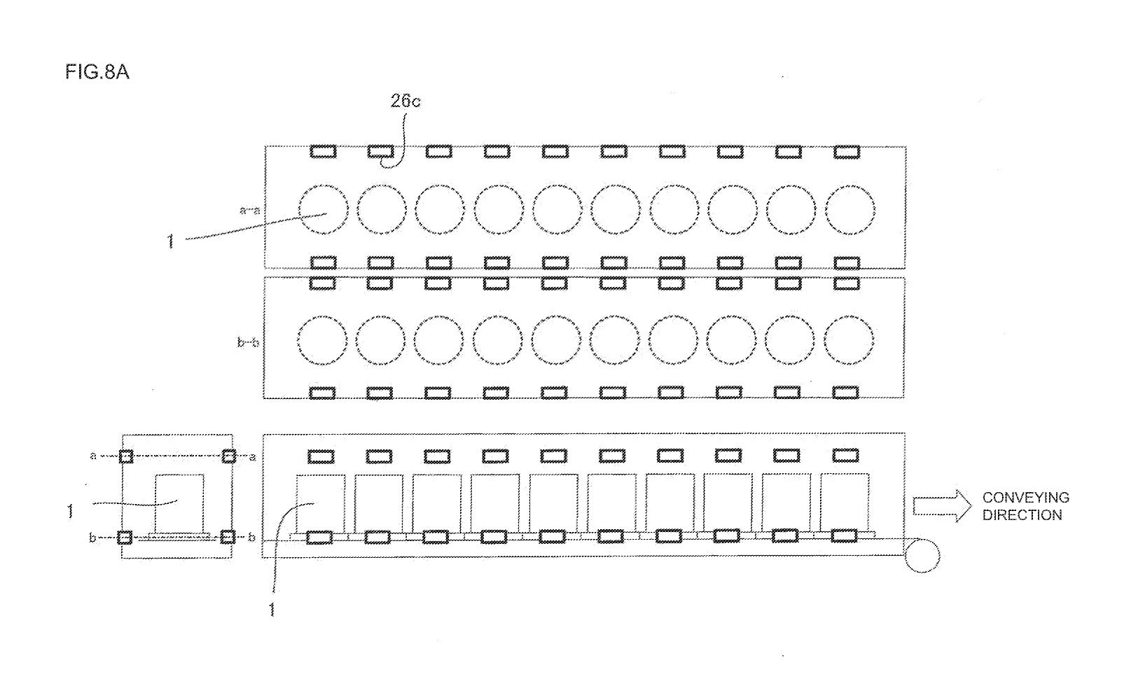

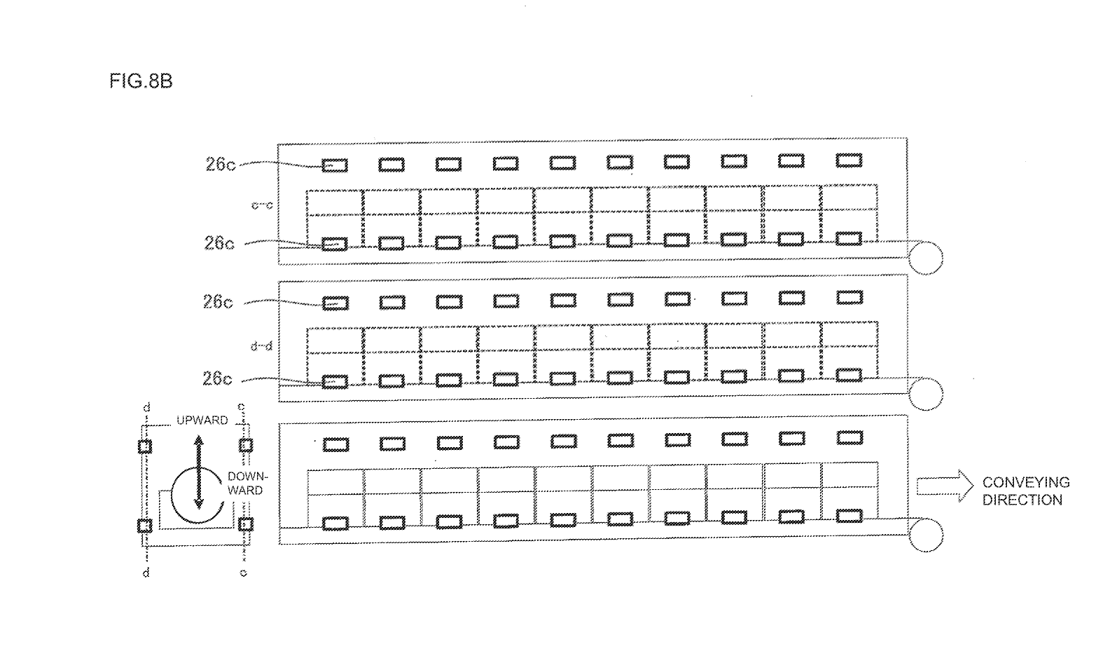

### Examples 1 to 7 and Comparative Example 1

[Honeycomb formed body] A cordierite raw material made by mixing alumina, kaolin, and talc was used as a ceramic raw material, and an axially forming agent containing methylcellulose (organic binder), an addition agent containing water-absorbing resin (pore-forming material), and water as a dispersion medium were mixed and kneaded to obtain clay. In this case, the mixed composition was set to be 4 parts by mass of methylcellulose and 2 parts by mass of water-absorbing resin. Subsequently, the obtained clay was extruded to form a honeycomb formed body 1 having a diameter of 360 millimeters, a length (axial length) of 380 millimeters, an outline shape of a cylinder, and a square shape of a cross section perpendicular to a central axis of the cell 3. A cell density of the obtained honeycomb formed body 1 was 300 cells/in² (in indicates an inch, which is 2.54 centimeters by SI unit system), and an opening area of an end surface was 70% of an area of the whole end surface (opening area ratio was 0.7). Moreover, a thickness of the partition wall 2 was 0.31 millimeter. A mass of the honeycomb formed body 1 was 29.5 kg, and a water content ratio thereof was 27%.

[Drying method] Microwave drying was performed on the obtained honeycomb formed body 1 for 15 minutes using the microwave drying apparatus 21 shown in FIGS. 1 and 2A in which a frequency was set to be 2450 MHz, and an output was 20 kW/piece. It is to be noted that in Examples 1 to 7, used were waveguides and placement of the honeycomb formed body shown in FIGS. 3A to 3E and 5A to 5B (the honeycomb formed body 1 was conveyed in a state where one of the opening end surfaces thereof was placed vertically downwardly on the drying tray (conveying pallet 24)), and in Comparative Example 1, used were those shown in FIG. 8A (refer to Table 1).

[Evaluation] The honeycomb formed body 1 on which microwave drying was performed was sliced into five disks in an axial direction (height direction) as shown in FIG. 7A, and nine samples were sliced whose sliced size was 10 by 10 by 10 millimeters in the respective disks. A remaining water percentage was then calculated as follows. First, a mass of a weighing bottle was measured (Ag), and next, the sample was put into the weighing bottle to measure amass (Bg). Subsequently, after the sample was heated to be dried for three hours by a small dryer in which a temperature was set to be 105° C., it was moved to a desiccator to be cooled, and a mass thereof was measured (Cg). The remaining water percentage was calculated by substituting the respective values into the following equation.

Remaining water percentage=(B−C)÷(B−A)×100

Since a difference of remaining water percentages in an outer periphery position (measurement positions 1 and 9) is large as shown in FIG. 7A, a maximum water amount difference between in the measurement position 1 and in the measurement position 9 was defined as a water amount difference. In addition, presence/absence of cracks in the honeycomb formed body 1 after the microwave drying was confirmed by visual observation.

The results are shown in Table 1.

TABLE 1

| | | Percentage of | The number of | The number of | Percentage of | | |
|---|---|---|---|---|---|---|---|
| | Corresponding | parallel | upstream | downstream | upstream | Water amount | The number of |
| | drawing | directions | directions | directions | directions | difference | cracks |
| Comparative | FIG. 8A | 0% | 0 | 0 | 0% | 15% | 10/11 pieces |
| Example 1 | | | | | | | |
| Example 1 | FIG. 3A | 20% | 4 | 4 | 50% | 10% | 6/11 pieces |
| Example 2 | FIG. 3B | 30% | 6 | 6 | 50% | 7% | 0/10 pieces |
| Example 3 | FIG. 3C | 50% | 10 | 10 | 50% | 0% | 0/10 pieces |
| Example 4 | FIG. 3D | 70% | 14 | 14 | 50% | −7% | 0/10 pieces |
| Example 5 | FIG. 3E | 80% | 16 | 16 | 50% | −10% | 5/10 pieces |
| Example 6 | FIG. 5A | 20% | 4 | 4 | 50% | 6% | 0/10 pieces |
| Example 7 | FIG. 5B | 50% | 16 | 16 | 50% | −5% | 0/10 pieces |

In Examples 1 to 7 in which the waveguides 26 were provided from which microwaves were radiated parallelly in the conveying direction of the honeycomb formed bodies 1, the number of cracks decreased compared with Comparative Example 1 (refer to FIG. 8A). Particularly, in Examples 2 to 4 in which a percentage of parallelly directed waveguides 26 was 30 to 70%, cracks did not occur, and good results were obtained. In addition, Example 6 (refer to FIG. 5A) shows a case where the honeycomb formed bodies 1 were conveyed to be dried with an interval therebetween being set to be twice in the drying apparatus 21 in which directions of the waveguides 26 were the same in Example 2 (refer to FIG. 3B). Compared with Example 2, the water amount difference and the number of cracks were improved. Similarly in Example 7 (FIG. 5B), the water amount difference and the number of cracks were improved, but the water amount difference occurred in Example 7 as compared with Example 3, and thus an improved effect brought by conveying to dry the honeycomb formed bodies 1 with the interval therebetween being set to be twice was larger than in Example 6 in which the percentage of the parallelly directed waveguides 26 was less than 50%.

### Examples 8 to 12 and Comparative Example 2

Next, microwave drying was performed under a condition where directions of the irradiation ports were set to be vertical and upward and downward, i.e., more upward or downward than the vertical direction, and a percentage of the upward and downward directions was changed. The honeycomb formed body 1 was conveyed in a state of being placed on the drying tray (conveying pallet 24) so that one of the opening end surfaces of the honeycomb formed body 1 might be directed in the conveying direction thereof as shown in FIGS. 9A and 9B. The results are shown in Table 2. It is to be noted that in Table 2, the maximum water amount difference between in the measurement position 1 and in the measurement position 9 shown in FIG. 7B was defined as the water amount difference. In addition, in Comparative Example 2, arrangement of the waveguides is similar to that in Comparative Example 1, but a placed state of the honeycomb formed body 1 is different from that in Comparative Example 1 (the honeycomb formed body 1 was conveyed in a state of being vertically placed in Comparative Example 1, and laterally placed in Comparative Example 2).

TABLE 2

| | | Percentage of | | | | | |
|---|---|---|---|---|---|---|---|
| | | upward and | The number of | The number of | Percentage of | | |
| | Corresponding | downward | upward | downward | upward | Water amount | The number of |
| | drawing | directions | directions | directions | directions | difference | cracks |
| Comparative | FIG. 8B | 0% | 0 | 0 | 0% | 12% | 10/11 pieces |
| Example 2 | | | | | | | |
| Example 8 | FIG. 9A | 20% | 4 | 4 | 50% | 9% | 5/11 pieces |
| Example 9 | — | 30% | 6 | 6 | 50% | 6% | 0/10 pieces |
| Example 10 | FIG. 9B | 50% | 10 | 10 | 50% | 0% | 0/10 pieces |
| Example 11 | — | 70% | 14 | 14 | 50% | −6% | 0/10 pieces |
| Example 12 | — | 80% | 16 | 16 | 50% | −9% | 5/10 pieces |

Setting the percentage of the upwardly and downwardly directed waveguides to be 20 to 80% allowed the water amount difference to be decreased and the number of cracks to be decreased. Particularly, when the percentage of the upwardly and downwardly directed waveguides was 30 to 70%, cracks did not occur, and good results were obtained.

### Examples 13 to 16

Next, microwave drying was performed under a condition where a percentage of the upstream and downstream directed waveguides was changed when the percentage of parallelly directed ones was set to be 50%. The results are shown in Table 3. It is to be noted that a water amount difference in Table 3 indicates a water amount difference between a front surface side and a rear surface side of the honeycomb formed body 1 in the conveying direction thereof as shown in FIG. 11.

TABLE 3

| | | Percentage of | The number of | The number of | Percentage of | | |
|---|---|---|---|---|---|---|---|
| | Corresponding | parallel | upstream | downstream | upstream | Water amount | The number of |
| | drawing | directions | directions | directions | directions | difference | cracks |
| Example 3 | FIG. 3C | 50% | 10 | 10 | 50% | 0% | 0/10 pieces |
| Example 13 | — | 50% | 6 | 14 | 30% | 8% | 3/10 pieces |
| Example 14 | FIG. 10A | 50% | 8 | 12 | 40% | 3% | 0/10 pieces |
| Example 15 | FIG. 10B | 50% | 12 | 8 | 60% | −3% | 0/10 pieces |
| Example 16 | — | 50% | 14 | 6 | 70% | −8% | 3/10 pieces |

When the percentage of the upstream directed waveguides was 40 to 60%, cracks did not occur, and good results were obtained.

A drying apparatus for ceramic formed bodies according to the present invention can be suitably utilized as drying means for honeycomb formed bodies (unfired bodies) in a process of manufacturing high-quality honeycomb structures widely used for various filters etc. including DPFs and catalyst carriers.

What is claimed is:

1. A drying apparatus for a honeycomb formed body, that is capable of obtaining a dried honeycomb formed body by irradiating with microwaves and microwave-heating an undried honeycomb formed body as the undried honeycomb formed body which is composed of a raw material composition containing a ceramic material and water, and in which a plurality of cells is partitioned and formed by partition walls, and thereby evaporating water from an inside and an outside of said undried honeycomb formed body to dry said undried honeycomb formed body, the drying apparatus comprising:
a drying chamber having a drying space to store said undried honeycomb formed body;
a microwave generator generating said microwaves to be irradiated to the undried honeycomb formed body that is stored in said drying chamber is radiated; and
a plurality of waveguides for introducing the microwaves generated by said microwave generator into said drying chamber, wherein
on side surfaces of said drying chamber, provided is a plurality of microwave introduction ports for introducing the microwaves generated by said microwave generator into said drying space inside the drying chamber,
said waveguides are disposed at said microwave introduction ports, and
irradiation ports of said waveguides are provided directed to two or more different directions toward said drying space of said drying chamber.

2. The drying apparatus for a honeycomb formed body according to claim 1, wherein flanges are formed for removably holding said waveguides provided toward said drying space at said microwave introduction ports on the side surfaces of said drying chamber.

3. The drying apparatus for a honeycomb formed body according to claim 2, wherein said waveguides are formed into a bent shape to change directions of said microwaves in said drying chamber and have flanges for allowing the flanges to be removable from said flanges of said drying chamber, and the radiation directions of said microwaves can be changed depending on attachment directions of said waveguides to said flanges of said drying chamber.

4. The drying apparatus for a honeycomb formed body according to claim 1, which is a continuous drying apparatus that continuously introduces/discharges a plurality of said honeycomb formed bodies into/from said drying chamber, wherein
said irradiation ports of said waveguides are provided parallel or vertical with respect to a conveying direction of said honeycomb formed bodies in said drying chamber.

5. The drying apparatus for a honeycomb formed body according to claim 4, wherein a percentage of the parallel direction of the waveguides is 30 to 70%.

6. The drying apparatus for a honeycomb formed body according to claim 5, wherein a percentage of an upstream direction in said conveying direction of said parallelly directed waveguides is 40 to 60%.

7. The drying apparatus for a honeycomb formed body according to claim 1, which is a continuous drying apparatus that continuously introduces/discharges a plurality of said honeycomb formed bodies into/from said drying chamber, wherein
the directions of said irradiation ports of said waveguides are set in vertical directions with respect to the conveying direction of said honeycomb formed bodies in said drying chamber and in upward/downward directions to be more upward or downward than said vertical directions, and a percentage of the upward/downward directions is 30 to 70%.

8. The drying apparatus for a honeycomb formed body according to claim 7, wherein a percentage of the upward waveguides in said upward and downward waveguides is 50%.

9. A drying method for honeycomb formed bodies using a drying apparatus for a honeycomb formed body according to claim 1, wherein
said honeycomb formed bodies are conveyed with an interval therebetween not less than twice as long as a distance between said irradiation ports.

10. A drying method for honeycomb formed bodies using a drying apparatus for a honeycomb formed body according to claim 4, wherein
said honeycomb formed bodies are conveyed with an interval therebetween not less than twice as long as a distance between said irradiation ports.

11. A drying method for honeycomb formed bodies using a drying apparatus for a honeycomb formed body according to claim 7, wherein
said honeycomb formed bodies are conveyed with an interval therebetween not less than twice as long as a distance between said irradiation ports.
